(19) United States
(12) Patent Application Publication
(10) Pub. No.: US 2019/0357269 A1
(43) Pub. Date: Nov. 21, 2019

(54) GRANT-FREE TRANSMISSION METHOD, TERMINAL DEVICE, AND NETWORK DEVICE

(71) Applicant: HUAWEI TECHNOLOGIES CO., LTD., Shenzhen (CN)

(72) Inventors: Yiqun WU, Shanghai (CN); Yan CHEN, Shanghai (CN)

(21) Appl. No.: 16/508,306

(22) Filed: Jul. 11, 2019

Related U.S. Application Data
(63) Continuation of application No. PCT/CN2017/108347, filed on Oct. 30, 2017.

(30) Foreign Application Priority Data
Jan. 12, 2017 (CN) 201710019826.6

(51) Int. Cl. H04W 74/08; H04W 72/04

(52) U.S. Cl. CPC H04W 74/0833; H04W 72/044

(57) ABSTRACT

A grant-free transmission method is provided. Under the method, a target time-frequency resource used for grant-free transmission can be determined by a terminal device from a plurality of time-frequency resources. A sequence corresponding to the target time-frequency resource can be determined by the terminal device based on information about the target time-frequency resource and a correspondence between a time-frequency resource and a sequence. The grant-free transmission with a network device can be performed on the target time-frequency resource based on the sequence corresponding to the target time-frequency resource. In this way, the network device can effectively determine, based on the sequence sent by the terminal device, a time-frequency resource used by the terminal device for the grant-free transmission.

### CROSS-REFERENCE TO RELATED APPLICATIONS

This application is a continuation of International Application No. PCT/CN2017/108347, filed on Oct. 30, 2017, which claims priority to Chinese Patent Application No. 201710019826.6, filed on Jan. 12, 2017. The disclosures of the aforementioned applications are hereby incorporated by reference in their entireties.

### TECHNICAL FIELD

The present disclosure relates to the communications field, and in particular, to a grant-free transmission method, a terminal device, and a network device in the communications field.

### BACKGROUND

In a typical wireless communications system such as a long term evolution (Long Term Evolution, LTE) system, a base station notifies, by delivering a control message, user equipment of information about a time-frequency resource used for uplink transmission. Because of different user types, quality of service (QoS) requirements, packet sizes, and channel states, the base station may flexibly configure an appropriate time-frequency resource for the user equipment. For example, when power of an edge user is limited, a narrowband or single carrier transmission scheme may be used to improve a signal-to-noise ratio (Signal-to-Noise Ratio, SNR); and a size of a time-frequency resource allocated to a to-be-transmitted packet may be determined based on a size of the to-be-transmitted packet.

However, in an uplink grant-free access (Grant-Free Access, GFA) mode, because the user equipment performs uplink transmission access independently without a dynamic scheduling instruction and an explicit scheduling instruction of the base station, it is difficult to effectively use radio transmission resources. Therefore, how to effectively determine a time-frequency resource used by the user equipment for grant-free access is a problem that needs to be urgently resolved.

### SUMMARY

Embodiments of the present disclosure provide a grant-free transmission method, a terminal device, and a network device, so that the network device can effectively determine a time-frequency resource selected by the terminal device for performing grant-free transmission.

According to a first aspect, a grant-free transmission method is provided. The method includes:

determining, by a terminal device, a target time-frequency resource used for grant-free transmission from a plurality of time-frequency resources;

determining, by the terminal device based on information about the target time-frequency resource and a correspondence between a time-frequency resource and a sequence, a sequence corresponding to the target time-frequency resource; and performing, by the terminal device, the grant-free transmission with a network device on the target time-frequency resource based on the sequence corresponding to the target time-frequency resource.

Therefore, the terminal device indicates, to the network device by using a sequence sent by the terminal device, a time-frequency resource currently used for grant-free access, so that the network device can effectively determine the time-frequency resource selected by the terminal device to perform the grant-free access. In addition, because reuse of a plurality of grant-free transmission resources is supported, effective utilization of radio transmission resources is implemented. Further, a transmission process may be simplified, and complexity of a receiver is reduced.

In one embodiment of the first aspect, determining the target time-frequency resource used for the grant-free transmission from a plurality of time-frequency resources includes:

determining, by the terminal device based on a size of to-be-sent uplink data or a loss status of a path between the terminal device and the network device, the target time-frequency resource used for the grant-free transmission from the plurality of time-frequency resources.

In one embodiment of the first aspect, the information about the target time-frequency resource includes at least one of the following information: a start location of the target time-frequency resource, a size of a frequency domain resource of the target time-frequency resource, a size of a time domain resource of the target time-frequency resource, or a frequency hopping mode of the terminal device.

In one embodiment, when a plurality of selectable time-frequency resources, for example, time-frequency resources of a same size but having different start locations, are used for the grant-free transmission, the terminal device may randomly select one of these time-frequency resources as the target time-frequency resource.

In addition, different time-frequency resources used for the grant-free transmission are corresponding to different sequences, and each time-frequency resource may be corresponding to one or more sequences.

In one embodiment of the first aspect, the performing, by the terminal device, the grant-free transmission with a network device on the target time-frequency resource based on the sequence corresponding to the target time-frequency resource includes: sending, by the terminal device, the sequence to the network device on a time-frequency resource used to send the sequence, and sending uplink data to the network device on the target time-frequency resource.

In one embodiment of the first aspect, a first location relationship is met between the time-frequency resource of the sequence and the target time-frequency resource, and the first location relationship includes that: the time-frequency resource of the sequence is adjacent to the target time-frequency resource in time domain and is followed by the target time-frequency resource, and includes all or some frequency domain resources of the target time-frequency resource in frequency domain.

Because a specific location relationship is met between the time-frequency resource used to transmit the sequence and the target time-frequency resource used to transmit the uplink data, after receiving the sequence sent by the terminal device, the network device may directly determine, based on a time-frequency resource on which the sequence is received, the time-frequency resource used by the terminal device to transmit the uplink data; that is, the sequence sent by the terminal device implicitly indicates a resource used for uplink grant-free transmission, and no other signaling is required to indicate the resource, thereby reducing signaling overheads in a system.

In one embodiment of the first aspect, the performing, by the terminal device, the grant-free transmission with a network device on the target time-frequency resource based on the sequence corresponding to the target time-frequency resource includes: sending, by the terminal device, the sequence to the network device on a time-frequency resource used to send the sequence, and sending a control signal and uplink data to the network device on the target time-frequency resource, where the control signal includes information about a time-frequency resource used to transmit the uplink data.

It should be understood that the uplink data herein refers to service data, and the control signal carries control information other than the uplink data. In this embodiment of this disclosure, the control signal carries the information about the time-frequency resource of the uplink data, such as a start location, bandwidth, and a quantity of timeslots, and if transmission of the uplink data supports frequency hopping, the control signal may further carry a corresponding frequency hopping mode. In addition, the control signal may carry information such as a user identity (Identity, ID), a modulation and coding scheme (Modulation and Coding Scheme, MCS) of data, an interleaving scheme, and a spreading code. The control signal and the uplink data are separately encoded, and the control signal and a data signal may share a same channel or use different channels for transmission.

In one embodiment of the first aspect, a second location relationship is met between the time-frequency resource of the sequence and a time-frequency resource used to transmit the control signal, and the second location relationship includes that: the time-frequency resource of the sequence is adjacent to the time-frequency resource of the control signal in time domain and is followed by the time-frequency resource of the control signal, and includes all or some frequency domain resources of the time-frequency resource of the control signal in frequency domain.

Because a specific location relationship is met between the time-frequency resource used to transmit the sequence and the time-frequency resource used to transmit the control signal, after receiving the sequence sent by the terminal device, the network device may directly determine, based on the time-frequency resource on which the sequence is received, the time-frequency resource used by the terminal device to transmit the control signal, and determine the resource used for the uplink grant-free transmission based on resource information carried in the control signal; that is, the sequence sent by the terminal device implicitly indicates the resource used for the uplink grant-free transmission, and no other signaling is required to indicate the resource, thereby reducing signaling overheads in the system.

In one embodiment of the first aspect, the sequence includes a preamble sequence or a reference signal.

According to a second aspect, a grant-free transmission method is provided, and the method includes:

detecting, by a network device, a sequence sent by a terminal device;

determining, by the network device based on the detected sequence, information about a target time-frequency resource used for grant-free transmission;

and detecting, by the network device on the target time-frequency resource, uplink data sent by the terminal device.

In this way, the network device can effectively determine a time-frequency resource used by the terminal device for grant-free access by using information about the sequence sent by the terminal device. Because reuse of a plurality of grant-free transmission resources is supported, effective utilization of radio transmission resources is implemented. Further, a transmission process may be simplified, and complexity of a receiver is reduced.

In one embodiment of the second aspect, before the detecting, by a network device, a sequence sent by a terminal device, the method further includes: determining, by the network device based on signal power, whether the terminal device sends the sequence; and when determining that the terminal device sends the sequence, detecting the sequence sent by the terminal device.

Using a preamble sequence as an example, a received signal of each resource unit is y=[y₁, y₂, . . . yₖ]^{T}, a to-be-detected preamble sequence is x=[x₁, x₂, . . . , xₖ]^{T}, where [ . . . ]^{T} represents transposition of a vector or a matrix. Then, the network device may calculate, according to a formula (1), signal power corresponding to the preamble sequence, and determine, by comparing the signal power with a preset power threshold, whether the terminal device sends the preamble sequence. If one or more preamble sequences are detected, the uplink data sent by the terminal device is further detected in a target time-frequency resource corresponding to the preamble sequence or target time-frequency resources corresponding to the plurality of preamble sequences; or if no preamble sequence is detected, no subsequent detection is performed.

$$P = {\vert {x}^{T} y \vert}^{2} = {\vert {\sum }_{i = 1}^{k} {x}_{i} {y}_{i} \vert}^{2} \qquad ( 1 )$$

In one embodiment of the second aspect, the information about the target time-frequency resource includes at least one of the following information: a start location of the target time-frequency resource, a size of a frequency domain resource of the target time-frequency resource, a size of a time domain resource of the target time-frequency resource, or a frequency hopping mode of the terminal device.

In one embodiment of the second aspect, the determining, by the network device based on the detected sequence, information about a target time-frequency resource used for grant-free transmission includes: determining, by the network device, the information about the target time-frequency resource based on the sequence and a correspondence between a sequence and a time-frequency resource.

In one embodiment of the second aspect, a first location relationship is met between the time-frequency resource of the sequence and the target time-frequency resource, and the first location relationship includes that: the time-frequency resource of the sequence is adjacent to the target time-frequency resource in time domain and is followed by the target time-frequency resource, and includes all or some frequency domain resources of the target time-frequency resource in frequency domain.

Because a specific location relationship is met between the time-frequency resource used to transmit the sequence and the target time-frequency resource used to transmit the uplink data, after receiving the sequence sent by the terminal device, the network device may directly determine, based on a time-frequency resource on which the sequence is received, the time-frequency resource used by the terminal device to transmit the uplink data; that is, the sequence sent by the terminal device implicitly indicates a resource used for uplink grant-free transmission, and no other signaling is required to indicate the resource, thereby reducing signaling overheads in a system.

In one embodiment of the second aspect, the determining, by the network device based on the detected sequence, information about a target time-frequency resource used for grant-free transmission includes: determining, by the network device based on a time-frequency resource used to transmit the sequence, a time-frequency resource that is in the target time-frequency resource and that is used to transmit a control signal, and receiving, on the time-frequency resource of the control signal, the control signal sent by the terminal device, where the control signal includes information about a time-frequency resource that is in the target time-frequency resource and that is used to transmit the uplink data; and determining, by the network device based on the control signal, the time-frequency resource that is in the target time-frequency resource and that is used to transmit the uplink data; and

the detecting, by the network device on the target time-frequency resource, uplink data sent by the terminal device includes: detecting, by the network device on the time-frequency resource that is in the target time-frequency resource and that is used to transmit the uplink data, the uplink data sent by the terminal device.

In one embodiment of the second aspect, a second location relationship is met between the time-frequency resource of the sequence and the time-frequency resource of the control signal, and the second location relationship includes that: the time-frequency resource of the sequence is adjacent to the time-frequency resource of the control signal in time domain and is followed by the time-frequency resource of the control signal, and includes all or some frequency domain resources of the time-frequency resource of the control signal in frequency domain.

In an implementation process, to simplify the design, a location of the time-frequency resource CR of the control signal and a location of the time-frequency resource of the sequence may be agreed upon in advance. For example, it may be agreed that the time-frequency resource of the sequence is adjacent to the CR in time domain and is followed by the CR, bandwidth of the time-frequency resources of the sequence is the same as bandwidth of the CR, and a quantity of timeslots of the CR is related to the bandwidth of the CR, that is, may be determined by the bandwidth of the CR. Then, the network device may directly determine a start location and the bandwidth of the CR based on a time-frequency resource of a detected preamble sequence, and determine the quantity of timeslots of the CR based on the bandwidth of the CR, and may further determine, in the control signal in the CR, a start location, bandwidth, and a quantity of timeslots of a time-frequency resource DR of the uplink data. If it is also agreed that the CR is adjacent to the DR, the start location and the quantity of timeslots of the CR directly determine the start location of the DR, and the control signal may not include the start location of the DR. If it is also agreed that the bandwidth of the CR and DR is the same, the control message does not need to carry bandwidth information of the DR. If transmission bandwidth of the DR includes only a possible quantity of timeslots of the DR, the control message does not need to indicate the quantity of timeslots of the DR. When data transmission supports the frequency hopping, the control messages may also indicate a frequency hopping mode of the data transmission.

Because a specific location relationship is met between the time-frequency resource used to transmit the sequence and the time-frequency resource used to transmit the control signal, after receiving the sequence sent by the terminal device, the network device may directly determine, based on the time-frequency resource on which the sequence is received, the time-frequency resource used by the terminal device to transmit the control signal, and determine the resource used for the uplink grant-free transmission based on resource information carried in the control signal; that is, the sequence sent by the terminal device implicitly indicates the resource used for the uplink grant-free transmission, and no other signaling is required to indicate the resource, thereby reducing signaling overheads in the system.

In one embodiment of the second aspect, the sequence includes a preamble sequence or a reference signal.

According to a third aspect, a terminal device is provided, and the terminal device may be configured to perform the processes performed by the terminal device in the grant-free transmission method in the first aspect and in the implementations of the first aspect. The network device includes a determining unit and a transmission unit. The determining unit is configured to determine a target time-frequency resource used for the grant-free transmission from a plurality of time-frequency resources. The determining unit is further configured to determine, based on information about the target time-frequency resource and a correspondence between a time-frequency resource and a sequence, a sequence corresponding to the target time-frequency resource. The transmission unit is configured to perform the grant-free transmission with a network device on the target time-frequency resource based on the sequence that is determined by the determining unit and that is corresponding to the target time-frequency resource.

According to a fourth aspect, a network device is provided, and the network device may be configured to perform the processes performed by the network device in the grant-free transmission method in the second aspect and in the implementations of the second aspect. The network device includes a detection unit and a determining unit. The detection unit is configured to detect a sequence sent by a terminal device. The determining unit is configured to determine, based on the sequence detected by the detection unit, information about a target time-frequency resource used for the grant-free transmission. The detection unit is further configured to detect, on the target time-frequency resource determined by the determining unit, uplink data sent by the terminal device.

According to a fifth aspect, a terminal device is provided, and the terminal device includes a processor, a transceiver, and a memory. The memory stores a program, and the processor executes the program to perform the processes performed by the terminal device in the grant-free transmission method in the first aspect and in the implementations of the first aspect. The processor is specifically configured to: determine a target time-frequency resource used for the grant-free transmission from a plurality of time-frequency resources; and determine, based on information about the target time-frequency resource and a correspondence between a time-frequency resource and a sequence, a sequence corresponding to the target time-frequency resource. The transceiver is specifically configured to perform the grant-free transmission with a network device on the target time-frequency resource based on the sequence that is determined by the processor and that is corresponding to the target time-frequency resource.

According to a sixth aspect, a network device is provided, and the network device includes a processor, a transceiver, and a memory. The memory stores a program, and the processor executes the program to perform the processes performed by the network device in the grant-free transmission method in the second aspect and in the implementations of the second aspect. The processor is configured to: detect a sequence sent by a terminal device; determine, based on the detected sequence, information about a target time-frequency resource used for the grant-free transmission; and detect, on the determined target time-frequency resource, uplink data sent by the terminal device.

According to a seventh aspect, a computer readable storage medium is provided, and the computer readable storage medium stores a program, where the program enables a terminal device to perform any one of the grant-free transmission methods in the first aspect and the implementations of the first aspect.

According to an eighth aspect, a computer readable storage medium is provided, and the computer readable storage medium stores a program, where the program enables a network device to perform any one of the grant-free transmission methods in the second aspect and the implementations of the second aspect.

According to a ninth aspect, a system chip is provided, and the system chip includes an input interface, an output interface, a processor, and a memory, where the processor is configured to execute an instruction stored in the memory, and when the instruction is executed, the processor may implement any one of the methods in the first aspect or the implementations of the first aspect.

According to a tenth aspect, a system chip is provided, and the system chip includes an input interface, an output interface, a processor, and a memory, where the processor is configured to execute an instruction stored in the memory, and when the instruction is executed, the processor may implement any one of the methods in the second aspect or the implementations of the second aspect.

Based on the method in the embodiments of this disclosure, the network device can determine, by using the information about the sequence sent by the terminal device, the time-frequency resource used by the terminal device for the grant-free access, so that effective utilization of the radio transmission resources is implemented. Because reuse of a plurality of grant-free transmission resources is supported, transmission resources are saved, and utilization of the time-frequency resource is improved. Further, a transmission process may be simplified, and complexity of a receiver is reduced.

### BRIEF DESCRIPTION OF DRAWINGS

FIG. 1 is a schematic diagram of an application scenario according to an embodiment of the present disclosure;

FIG. 2 is a schematic diagram of an uplink grant-free transmission method in the prior art;

FIG. 3 is a schematic interaction diagram of a grant-free transmission method according to an embodiment of the present disclosure;

FIG. 4 is a schematic diagram of a time-frequency resource used for grant-free transmission according to an embodiment of the present disclosure;

FIG. 5 is a schematic diagram of a time-frequency resource used for grant-free transmission according to an embodiment of the present disclosure;

FIG. 6 is a schematic diagram of a time-frequency resource used for grant-free transmission according to an embodiment of the present disclosure;

FIG. 7 is a schematic diagram of a time-frequency resource used for grant-free transmission according to an embodiment of the present disclosure;

FIG. 8 is a schematic diagram of a time-frequency resource used for grant-free transmission according to an embodiment of the present disclosure;

FIG. 9 is a schematic diagram of a time-frequency resource used for grant-free transmission according to an embodiment of the present disclosure;

FIG. 10 is a schematic block diagram of a terminal device according to an embodiment of the present disclosure;

FIG. 11 is a schematic structural diagram of a terminal device according to an embodiment of the present disclosure;

FIG. 12 is a schematic block diagram of a network device according to an embodiment of the present disclosure;

FIG. 13 is a schematic structural diagram of a network device according to an embodiment of the present disclosure; and

FIG. 14 is a schematic structural diagram of a system chip according to an embodiment of the present disclosure.

### DESCRIPTION OF EMBODIMENTS

The technical solutions of the present disclosure will be described with reference to the accompanying drawings.

Terms such as “component”, “module”, and “system” used in this disclosure are used to indicate computer-related entities, hardware, firmware, combinations of hardware and software, software, or software being executed. For example, a component may be, but is not limited to, a process that runs on a processor, a processor, an object, an executable file, a thread of execution, a program, and/or a computer. As shown in the figures, both a computing device and an application that runs on a computing device may be referred to as components. One or more components may reside within a process and/or a thread of execution, and a component may be located on one computer and/or distributed between two or more computers. In addition, these components may be executed by various computer-readable media that store various data structures. For example, the components may communicate by using a local and/or remote process and according to, for example, a signal having one or more data packets (for example, data from two components interacting with another component in a local system, a distributed system, and/or across a network such as the Internet interacting with other systems by using the signal).

It should be understood that the technical solutions in the embodiments of this disclosure may be applied to various communications systems, such as: a global system for mobile communications (Global System for Mobile Communications, GSM) system, a code division multiple access (Code Division Multiple Access, CDMA) system, a wideband code division multiple access (Wideband Code Division Multiple Access, WCDMA) system, a long term evolution (Long Term Evolution, LTE) system, an LTE frequency division duplex (Frequency Division Duplex, FDD) system, an LTE time division duplex (Time Division Duplex, TDD) system, a universal mobile telecommunications system (Universal Mobile Telecommunications System, UMTS), and a future 5G communications system, or the like.

The present disclosure describes embodiments with reference to a terminal device. The terminal device may be referred to user equipment (User Equipment, UE), an access terminal, a subscriber unit, a subscriber station, a mobile station, a mobile console, a remote station, a remote terminal, a mobile device, a user terminal, a terminal, a wireless communication device, a user agent, a user apparatus. An access terminal may be a cellular phone, a cordless phone, a session initiation protocol (Session Initiation Protocol, SIP) phone, a wireless local loop (Wireless Local Loop, WLL) station, a personal digital assistant (Personal Digital Assistant, PDA), a handheld device having a wireless communication function, a computing device, another processing device connected to a wireless modem, an in-vehicle device, a wearable device, a terminal device in a future 5G network, or a terminal device in a future evolved PLMN network.

The present disclosure describes embodiments with reference to a network device. The network device may be a device configured to communicate with the terminal device. For example, the network device may be a base transceiver station (Base Transceiver Station, BTS) in a GSM system or a CDMA system, a NodeB (NodeB, NB) in a WCDMA system, or an evolved NodeB (Evolved NodeB, eNB or eNodeB) in an LTE system. Alternatively, the network device may be a relay station, an access point, an in-vehicle device, a wearable device, a network side device in the future 5G network, a network device in the future evolved PLMN network, or the like.

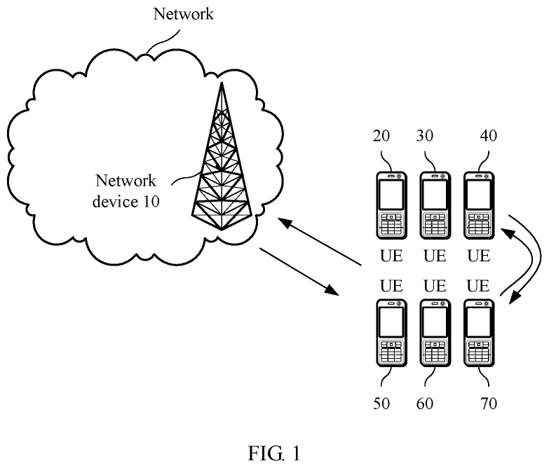

FIG. 1 is a schematic architectural diagram of a communications system to which an embodiment of the present disclosure can be applied. As shown in FIG. 1, the communications system may include a network device 10 and a terminal device 20 to a terminal device 70 (referred to as UE in the figure), where the network device and the terminal device are connected in a wireless manner, a wired manner, or another manner. The terminal device 20 to the terminal device 70 may communicate with the network device 10 in a grant-free access manner.

A network in the embodiments of this disclosure may be a public land mobile network (Public Land Mobile Network, PLMN), a device-to-device (Device-to-Device, D2D) network, a machine-to-machine/man (Machine-to-Machine/Man, M2M) network, or another network. FIG. 1 is merely a simplified schematic diagram used as an example, and the network may further include another network device that is not shown in FIG. 1.

The solutions provided in the embodiments of this disclosure may be applied to grant-free access, and the grant-free access herein may also be referred to as grant-free (Grant-free) transmission. The grant-free transmission may support a plurality of services in a future network, such as a machine type communication (Machine Type Communication, MTC) service or an ultra-reliable and low latency communication (Ultra-Reliable and Low Latency Communication, URLLC) service, so as to meet service transmission requirements for low latency and high reliability. The grant-free transmission may be specific to uplink data transmission. A person skilled in the art may know that the grant-free access may also have another name, such as spontaneous access, spontaneous multiple access, or contention-based multiple access.

In the embodiments of this disclosure, the data may include service data or signaling data. Transmission resources used for the grant-free transmission may include but are not limited to any one of or a combination of a plurality of the following resources: a time domain resource, such as a radio frame, a subframe, or a symbol; a frequency domain resource, such as a subcarrier or a resource block; a space domain resource, such as a transmit antenna or a beam; a code domain resource, such as a sparse code multiple access (Sparse Code Multiple Access, SCMA) codebook group, a low density signature (Low Density Signature, LDS) group, or a CDMA code group; an uplink pilot resource; an interleaving resource; or a channel coding scheme.

Transmission may be performed on the foregoing transmission resources according to control mechanisms that include but are not limited to the following: uplink power control, such as uplink transmit power upper limit control; modulation and coding scheme setting, such as transport block size setting, code rate setting, or modulation order setting; a retransmission mechanism, such as a hybrid automatic repeat request (Hybrid Automatic Repeat Request, HARQ); and the like.

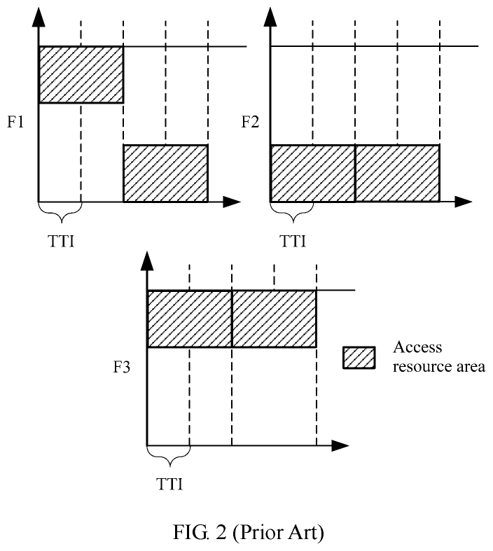

FIG. 2 is a schematic diagram of an uplink grant-free transmission method in the prior art. As shown in FIG. 2, a base station is preconfigured with a plurality of time-frequency resource blocks of different sizes for uplink grant-free transmission. The time-frequency resource blocks are independent of each other, and each time-frequency resource block may occupy at least one transmission time interval (Transmission Time Interval, TTI). The three parts in FIG. 2 respectively show three time-frequency resources of different sizes that are preconfigured for the base station for the uplink grant-free transmission. However, in this method, utilization of the time-frequency resource is very low when there are many types of user equipment but a quantity of user equipment is small. In addition, when receiving data, the base station needs to detect the data separately on each time-frequency resource block, and consequently, processing complexity is high.

In the embodiments of this disclosure, the network device may determine, by using information about a sequence sent by the user equipment, a time-frequency resource used by the user equipment for grant-free access, so that effective utilization of radio transmission resources can be implemented.

It should be understood that a preamble sequence (preamble) mentioned in the embodiments of this disclosure may also be referred to as a preamble. For example, the preamble sequence may be a ZC (Zadoff Chu) sequence, a pseudo noise (Pseudo Noise, PN) sequence, a longest linear shift register sequence (M sequence for short, that is, a basic PN sequence used in a CDMA system), a Walsh sequence, or the like. A reference signal (Reference Signal, RS) mentioned in the embodiments of this disclosure may also be referred to as a pilot signal, and is a signal provided by a transmit end for a receive end for channel estimation, channel detection, or channel state detection.

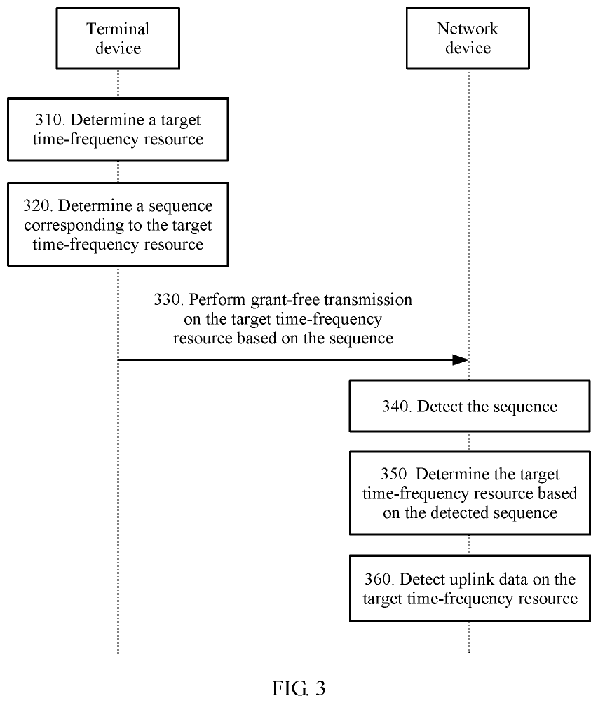

FIG. 3 is a schematic interaction diagram of a grant-free transmission method according to an embodiment of this disclosure. In the method shown in FIG. 3, a transmit end of a sequence, data, or the like may be a terminal device or a network device, and a receive end of the sequence, the data, or the like may be a terminal device or a network device.

The following uses an example in which the transmit end of the sequence, the data, or the like is a terminal device and the receive end is a network device for description. However, this embodiment of the present disclosure is not limited thereto. For example, the transmit end of the sequence, the data, or the like is a terminal device, and the receive end of the sequence, the data, or the like is another terminal device, and in this case, the method in this embodiment of this disclosure may be applied to D2D transmission.

FIG. 3 is a schematic interaction diagram illustrating a grant-free transmission method between a network device and a terminal device. Referring to FIG. 3, the network device may be a network device 10 in FIG. 1, and the terminal device may be any one of a terminal device 20 to a terminal device 70 in FIG. 1. Only one terminal device is used as an example for description herein. However, grant-free transmission may be performed between the network device and a plurality of terminal devices that include the terminal device by using the method in this embodiment of this disclosure. For a method performed by another terminal device, refer to the method performed by the terminal device shown in FIG. 3. For brevity, details are not described herein again. Optionally, the method may be applied to the grant-free transmission, or may be applied to another scenario. An example in which the method is applied to the grant-free transmission is used for description herein; that is, uplink transmission performed between the terminal device and the network device is the grant-free transmission, and a used transmission resource is a grant-free transmission resource. As shown in FIG. 3, the grant-free transmission method includes the following steps.

In step 310, a terminal device determines a target time-frequency resource used for a current grant-free transmission from a plurality of time-frequency resources.

Specifically, when performing uplink grant-free access, the terminal device first needs to select the target time-frequency resource used to perform the uplink grant-free access, for example, determine the following information about the target time-frequency resource: a start location, occupied bandwidth, a quantity of timeslots, and the like. The terminal device may determine the target time-frequency resource used for the current grant-free transmission from the plurality of preconfigured time-frequency resources.

For example, the terminal device may determine, based on a size of to-be-sent uplink data, the target time-frequency resource used for the grant-free transmission from the plurality of time-frequency resources; or the terminal device may determine, based on a loss status of a path between the terminal device and the network device, the target time-frequency resource used for the grant-free transmission from the plurality of time-frequency resources; or the terminal device may determine the target time-frequency resource based on other information. This is not limited in this embodiment of this disclosure.

In one embodiment, when a plurality of selectable time-frequency resources, for example, time-frequency resources of a same size but having different start locations, are used for the grant-free transmission, the terminal device may randomly select one of these time-frequency resources as the target time-frequency resource.

In step 320, the terminal device determines, based on information about the target time-frequency resource and a correspondence between a time-frequency resource and a sequence, a sequence corresponding to the target time-frequency resource.

In one embodiments, the information about the target time-frequency resource includes at least one of the following information: a start location of the target time-frequency resource, a size of a frequency domain resource of the target time-frequency resource, a size of a time domain resource of the target time-frequency resource, or a frequency hopping mode of the terminal device.

After determining the target time-frequency resource used for the grant-free transmission, the terminal device may determine, based on the information about the target time-frequency resource and the preset correspondence between the time-frequency resource and the sequence, the sequence that is corresponding to the target time-frequency resource and that is used for the grant-free transmission. Different time-frequency resources used for the grant-free transmission correspond to different sequences, and each time-frequency resource may correspond to one or more sequences.

The correspondence between the time-frequency resource and the sequence may be presented in a form such as a table, a formula, or an image; and in the correspondence, one time-frequency resource may correspond to one or more sequences, or one sequence may correspond to one or more time-frequency resources. That is, the terminal device may determine, by searching a preset table that includes correspondences between the plurality of time-frequency resources and the plurality of sequences, the sequence corresponding to the target time-frequency resource; or the terminal device may calculate, by using a preset formula and related parameter information of the target time-frequency resource, an identifier or a number of the sequence corresponding to the target time-frequency resource. This is not limited in this disclosure.

In one embodiment, the sequence corresponding to the target time-frequency resource includes a preamble sequence, or includes a reference signal such as a pilot sequence.

In this embodiment of this disclosure, the time-frequency resource used for the grant-free transmission may also be referred to as a grant-free access region (Grant-free Access Region, GFAR).

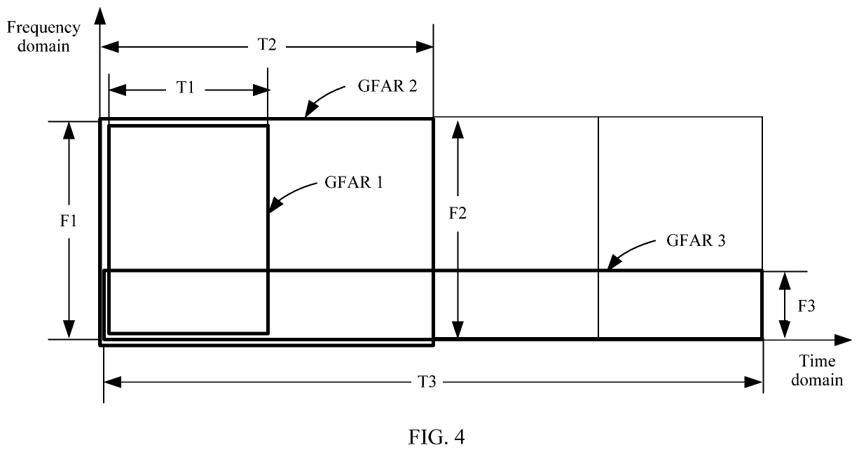

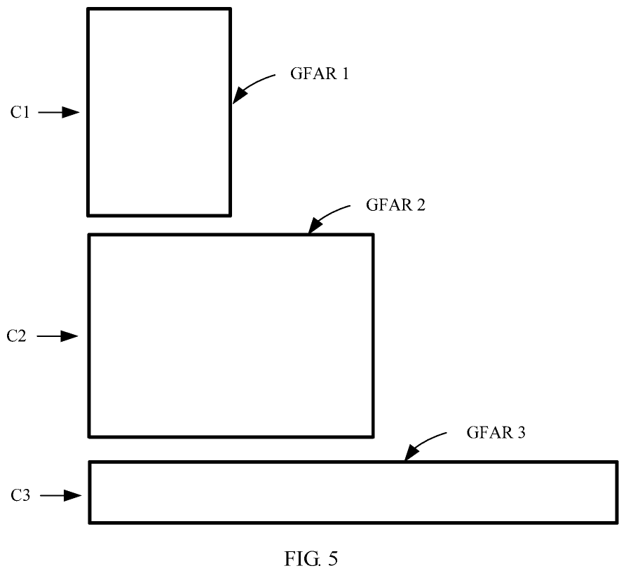

FIG. 4 and FIG. 5 show as an example of a correspondence between the time-frequency resource and the sequence according to an embodiment of the present disclosure. The correspondence may be determined and notified to the terminal device by the network device, or may be jointly negotiated and agreed upon by the network device and the terminal device. For example, the correspondence may be a correspondence specified in a protocol. FIG. 4 and FIG. 5 show three time-frequency resources used for the grant-free transmission, where a first time-frequency resource (GFAR 1), a second time-frequency resource (GFAR 2), and a third time-frequency resource (GFAR 3) have a same start location in time domain. Bandwidth F1 of the first time-frequency resource is the same as bandwidth F2 of the second time-frequency resource, and bandwidth of the third time-frequency resource is F3. A quantity T2 of timeslots of the second time-frequency resource is twice as large as a quantity T1 of timeslots of the first time-frequency resource, and a quantity T3 of timeslots of the third time domain resource is four times as large as the quantity T1 of timeslots of the first time domain resource.

More generally, at least one GFAR unit may be defined, and each GFAR unit has specific bandwidth, a specific quantity of timeslots, and the like. A GFAR used by the terminal device may include at least one GFAR unit.

FIG. 5 shows the correspondence between the time-frequency resource used for the grant-free transmission and the sequence. Using a preamble sequence as an example, it can be seen from FIG. 5 that the first time-frequency resource GFAR1 corresponds to a preamble sequence C1, the second time-frequency resource GFAR2 corresponds to a preamble sequence C2, and the third time-frequency resource GFAR3 corresponds to a preamble sequence C3. In other words, the preamble sequences C1, C2, and C3 are respectively corresponding to GFAR1, GFAR2, and GFRA3 of different sizes. Generally, preamble sequences corresponding to different GFARs have a same length. However, in this embodiment of this disclosure, different GFARs may also correspond to several groups of preamble sequences having different lengths, and this is not limited herein.

Based on information such as the size of the to-be-sent uplink data or a link loss status of the terminal device, the terminal device determines that the target time-frequency resource is the first time-frequency resource, the terminal device uses the preamble sequence C1 to perform the grant-free transmission with the network device on the first time-frequency resource; or the terminal device determines that the target time-frequency resource used by the terminal device is the second time-frequency resource, the terminal device uses the preamble sequence C2 to perform the grant-free transmission with the network device on the second time-frequency resource; or the terminal device determines that the target time-frequency resource used by the terminal device is the third time-frequency resource, the terminal device uses the preamble sequence C3 to perform the grant-free transmission with the network device on the third time-frequency resource. The preamble sequences C1, C2, and C3 may be ZC sequences commonly used in an LTE system, or may be PN sequences, M sequences, Walsh sequences, or the like.

When the terminal device supports frequency hopping, the information about the target time-frequency resource may further include the frequency hopping mode used by the terminal device. Using a frame structure of the LTE system as an example, an orthogonal frequency division multiplexing (Orthogonal Frequency Division Multiplexing, OFDM) technology is used at a physical layer, the bandwidth includes a specific quantity of subcarriers, and each timeslot includes a specific quantity of time domain symbols such as OFDM symbols. Each cell may define GFARs of different quantities and sizes, and the network device may instruct the terminal device to configure the foregoing GFARs by using, for example, a broadcast message or a control message.

In step 330, the terminal device performs the grant-free transmission with a network device on the target time-frequency resource based on the sequence.

When the terminal device determines the target time-frequency resource and the sequence (for example, the preamble sequence or the pilot sequence) that are used for the current grant-free transmission, the terminal device sends the uplink data to the network device on the target time-frequency resource based on the sequence.

In one embodiment, when performing the grant-free transmission with the network device, the terminal device may send the sequence to the network device on a time-frequency resource used to send the sequence, and send the uplink data to the network device on the target time-frequency resource. Optionally, a first location relationship is met between the time-frequency resource of the sequence and the target time-frequency resource, and the first location relationship may include that: the time-frequency resource of the sequence is adjacent to the target time-frequency resource in time domain and is followed by the target time-frequency resource, and includes all or some frequency domain resources of the target time-frequency resource in frequency domain.

In one embodiment, the terminal device may send the sequence to the network device on the time-frequency resource of the sequence, and send a control signal and the uplink data to the network device on the target time-frequency resource, where the control signal includes information about a time-frequency resource used to transmit the uplink data. In one embodiment, a second location relationship is met between the time-frequency resource of the sequence and the time-frequency resource used to transmit the control signal, and the second location relationship may include that: the time-frequency resource of the sequence is adjacent to the time-frequency resource of the control signal in time domain and is followed by the time-frequency resource of the control signal, and includes all or some frequency domain resources of the time-frequency resource of the control signal in frequency domain.

In step 340, the network device detects a sequence sent by the terminal device.

In one embodiment, before the network device detects the sequence sent by the terminal device, the method may further include: determining, by the network device based on a signal power, whether the terminal device sends the sequence, and when the network device determines that the terminal device sends the sequence, detecting the sequence sent by the terminal device.

Specifically, when receiving a signal, the network device may first determine, based on the signal power, whether the terminal device sends the sequence. Using the preamble sequence as an example, a received signal of each resource unit is y=[y₁, y₂, . . . yₖ]^{T}, and a to-be-detected preamble sequence is x=[x₁, x₂, . . . , xₖ]^{T}, where [ . . . ]^{T} represents the transposition of a vector or a matrix. Then, the network device may calculate, according to formula (1) below, the signal power corresponding to the preamble sequence, and determine, by comparing the signal power with a preset power threshold, whether the terminal device sends the preamble sequence. If one or more preamble sequences are detected, the uplink data sent by the terminal device is further detected in a GFAR corresponding to the preamble sequence or GFARs corresponding to the plurality of preamble sequences; or if no preamble sequence is detected, no subsequent detection is performed.

$$P = {\vert {x}^{T} y \vert}^{2} = {\vert {\sum }_{i = 1}^{k} {x}_{i} {y}_{i} \vert}^{2} \qquad ( 1 )$$

In step 350, the network device determines, based on the detected sequence, the information about the target time-frequency resource used for the grant-free transmission.

Specifically, two modes may be used by the network device to determine the information about the target time-frequency resource used for the grant-free transmission. One mode is to directly determine a corresponding target time-frequency resource based on the detected preamble sequence, and the other mode is to determine the information about the target time-frequency resource based on the control signal sent by the terminal device and the preamble sequence.

The following describes in detail the process utilized by the network device to determine, in the two modes, the information about the target time-frequency resource used for the grant-free transmission.

Mode 1

In one embodiment, in step 350, the network device determines, based on the detected sequence, the information about the target time-frequency resource used for the grant-free transmission. Step 350 includes: determining, by the network device, the information about the target time-frequency resource based on the sequence and the correspondence between the sequence and the time-frequency resource.

In some embodiments, after detecting the sequence, the network device may determine, based on the correspondence between the sequence and the time-frequency resource, the information about the target time-frequency resource used to receive the uplink data of the terminal device. For example, the network device may determine, based on the detected sequence and the correspondence, shown in FIG. 4 and FIG. 5, between the sequence and the time-frequency resource, the target time-frequency resource used to detect the uplink data. For example, if the network device detects the preamble sequence C1, the uplink data sent by the terminal device is detected on the first time-frequency resource corresponding to the preamble sequence C1, that is, the GFAR 1; or if the network device detects the preamble sequence C2, the uplink data sent by the terminal device is detected on the second time-frequency resource corresponding to the preamble sequence C2, that is, the GFAR 2; or if the network device detects the preamble sequence C3, the uplink data sent by the terminal device is detected on the third time-frequency resource corresponding to the preamble sequence C3, that is, the GFAR 3.

In one embodiment, the first location relationship is met between the time-frequency resource used to transmit the sequence and the target time-frequency resource, for example, the first location relationship may be that: the time-frequency resource of the sequence is adjacent to the target time-frequency resource in time domain and is followed by the target time-frequency resource, and includes all or some frequency domain resources of the target time-frequency resource in frequency domain.

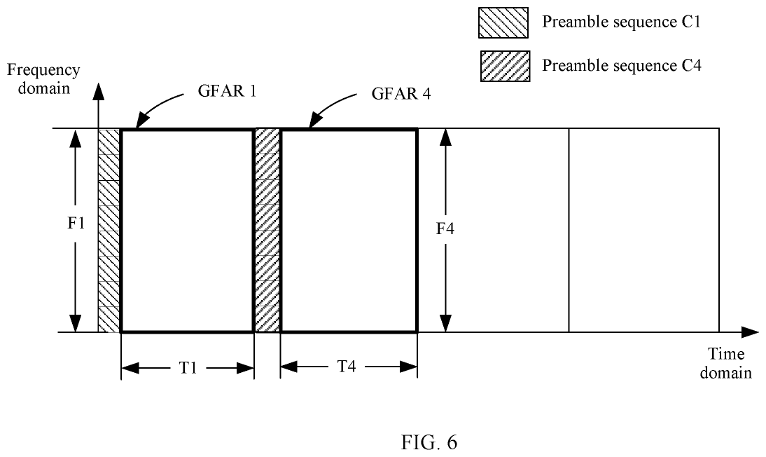

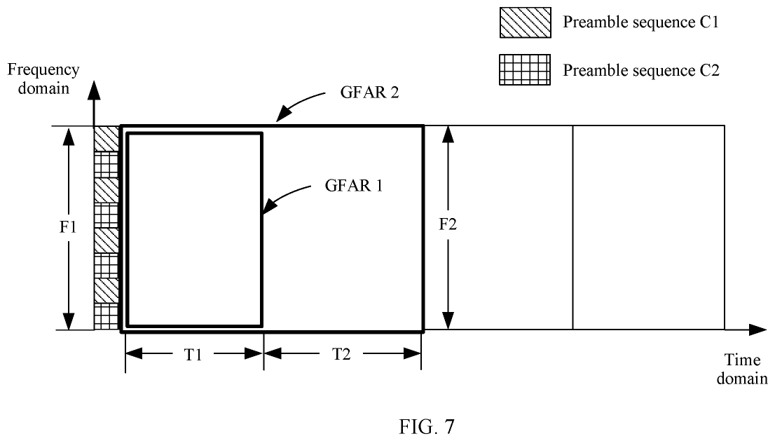

FIG. 6 and FIG. 7 show in detail two examples illustrating the first location relationship that is met between the time-frequency resource used by the terminal device to send the sequence and the target time-frequency resource.

FIG. 6 is a schematic diagram of the time-frequency resource used for the grant-free transmission according to an embodiment of the present disclosure. The first location relationship is met between the time-frequency resource used to transmit the sequence and the target time-frequency resource is that: the time-frequency resource of the sequence is adjacent to the target time-frequency resource in time domain and is followed by the target time-frequency resource, and includes all frequency domain resources of the target time-frequency resource in frequency domain. FIG. 6 shows a first time-frequency resource GFAR1 and a fourth time-frequency resource GFAR4. The bandwidth F1 of the first time-frequency resource is equal to bandwidth F4 of the fourth time-frequency resource, the quantity T1 of timeslots of the first time-frequency resource is equal to a quantity T4 of timeslots of the fourth time-frequency resource, and the start location of the first time-frequency resource comes before a start location of the fourth time-frequency resource.

If the terminal device determines that the target time-frequency resource is the first time-frequency resource, that is, the GFAR 1, the preamble sequence determined by the terminal device based on the GFAR 1 is the C1, and the terminal device sends the preamble sequence C1 to the network device at a location of a time-frequency resource of the preamble sequence C1 as shown in FIG. 6, and sends the uplink data to the network device on the GFAR 1. Then, if the network device detects the preamble sequence C1 on the time-frequency resource of the preamble sequence C1, the network device detects, on the first time-frequency resource corresponding to the preamble sequence C1 based on the preamble sequence C1, the uplink data sent by the terminal device.

If the terminal device determines that the target time-frequency resource is the fourth time-frequency resource, that is, the GFAR 4, the preamble sequence determined by the terminal device based on the GFAR 4 is the C4, and the terminal device sends the preamble sequence C4 to the network device at a location of the time-frequency resource of the preamble sequence C4 as shown in FIG. 6, and sends the uplink data to the network device on the GFAR 4. Then, if the network device detects the preamble sequence C4 on the time-frequency resource of the preamble sequence C4, the network device detects, on the fourth time-frequency resource corresponding to the preamble sequence C4 based on the preamble sequence C4, the uplink data sent by the terminal device.

FIG. 7 is a schematic diagram of the time-frequency resource used for the grant-free transmission according to an embodiment of the present disclosure. The first location relationship that is met between the time-frequency resource used to transmit the sequence and the target time-frequency resource is that: the time-frequency resource of the sequence is adjacent to the target time-frequency resource in time domain and is followed by the target time-frequency resource, and includes some frequency domain resources of the target time-frequency resource in frequency domain. FIG. 7 shows the first time-frequency resource GFAR1 and the second time-frequency resource GFAR2, the bandwidth F1 of the first time-frequency resource is equal to the bandwidth F2 of the second time-frequency resource, and the quantity T2 of timeslots included in the second time-frequency resource is twice as large as the quantity T1 of timeslots of the first time-frequency resource, and the start location of the first time-frequency resource is the same as the start location of the second time-frequency resource.

If the terminal device determines that the target time-frequency resource is the first time-frequency resource, that is, the GFAR 1, the preamble sequence determined by the terminal device based on the GFAR 1 is the C1, and the terminal device sends the preamble sequence C1 to the network device at a location of the time-frequency resource of the preamble sequence C1 as shown in FIG. 7, and sends the uplink data to the network device on the GFAR 1. Then, if the network device detects the preamble sequence C1 on the time-frequency resource of the preamble sequence C1, the network device detects, on the first time-frequency resource corresponding to the preamble sequence C1 based on the preamble sequence C1, the uplink data sent by the terminal device.

If the terminal device determines that the target time-frequency resource is the second time-frequency resource, that is, the GFAR 2, the preamble sequence determined by the terminal device based on the GFAR 2 is the C2, and the terminal device sends the preamble sequence C2 to the network device at a location of the time-frequency resource of the preamble sequence C2 as shown in FIG. 7, and sends the uplink data to the network device on the GFAR 2. Then, if the network device detects the preamble sequence C2 on the time-frequency resource of the preamble sequence C2, the network device detects, on the second time-frequency resource corresponding to the preamble sequence C2 based on the preamble sequence C2, the uplink data sent by the terminal device.

It can be learned that, when being transmitted, the preamble sequence C1 corresponding to the first time-frequency resource and the preamble sequence C2 corresponding to the second time-frequency resource occupy a same symbol, but a time-frequency resource used to transmit a preamble sequence includes some frequency domain resources of the target time-frequency resource in frequency domain. In the symbol, frequency domain resources used for transmitting the preamble sequence C1 and the preamble sequence C2 are cross-distributed in the frequency domain.

Because a specific location relationship is met between the time-frequency resource used to transmit the sequence and the target time-frequency resource used to transmit the uplink data, after receiving the sequence sent by the terminal device, the network device may directly determine, based on a time-frequency resource on which the sequence is received, the time-frequency resource used by the terminal device to transmit the uplink data; that is, the sequence sent by the terminal device implicitly indicates a resource used for uplink grant-free transmission, and no other signaling is required to indicate the resource, thereby reducing signaling overheads in a system.

Manner 2

Optionally, that the network device determines, based on the detected sequence, the information about the target time-frequency resource used for the grant-free transmission includes: determining, by the network device based on the time-frequency resource used to transmit the sequence, a time-frequency resource that is in the target time-frequency resource and that is used to transmit the control signal, and receiving, on the time-frequency resource of the control signal, the control signal sent by the terminal device; and determining, by the network device based on the control signal, the time-frequency resource that is in the target time-frequency resource and that is used to transmit the uplink data.

In one embodiment, the second location relationship is met between the time-frequency resource used to transmit the sequence and the time-frequency resource of the control signal, and the control signal includes the information about the time-frequency resource that is in the target time-frequency resource and that is used to transmit the uplink data.

In some embodiments, the terminal device sends the sequence to the network device on the time-frequency resource of the sequence, and sends the control signal and the uplink data to the network device on the target time-frequency resource. The network device determines, based on the time-frequency resource of the sequence, the time-frequency resource that is in the target time-frequency resource and that is used to transmit the control signal, and receives, on the time-frequency resource of the control signal, the control signal sent by the terminal device. Because the control signal carries the information, such as a start location, bandwidth, a quantity of timeslots, and the frequency hopping mode, about the time-frequency resource that is in the target time-frequency resource and that is used to transmit the uplink data, the network device receives the control signal, and determines, based on the control signal, the time-frequency resource that is in the target time-frequency resource and that is used to transmit the uplink data. In this case, the network device may detect the uplink data sent by the terminal device on the time-frequency resource that is in the target time-frequency resource and that is used to transmit the uplink data.

Herein, the time-frequency resource of the control signal may be referred to as a control region (Control Region, CR), and a time-frequency resource used to transmit the uplink data is referred to as a data region (Data Region, DR). The target time-frequency resource GFAR includes the CR and the DR.

Because the control signal also needs to be demodulated, location information of the CR needs to be determined before the control signal is demodulated. A most basic manner is that the sequence sent by the terminal device determines information about the CR, such as a start location, bandwidth, and a quantity of timeslots, and if the transmission of the control signal supports frequency hopping, the sequence may further be used to indicate a corresponding frequency hopping mode. The control signal may indicate information about the DR, such as a start location, bandwidth, and a quantity of timeslots, and if the transmission of the data supports frequency hopping, the control message may further indicate a corresponding frequency hopping mode.

It should be understood that the uplink data herein refers to service data, and the control signal carries control information other than the uplink data. In this embodiment of this disclosure, the control signal carries the information about the time-frequency resource of the uplink data, such as the start location, the bandwidth, and the quantity of timeslots. In addition, the control message may carry information such as a user identity (Identity, ID), a modulation and coding scheme (Modulation and Coding Scheme, MCS) of data, an interleaving scheme, and a spreading code. The control signal and the uplink data are separately encoded, and the control signal and a data signal may share a same channel or use different channels for transmission.

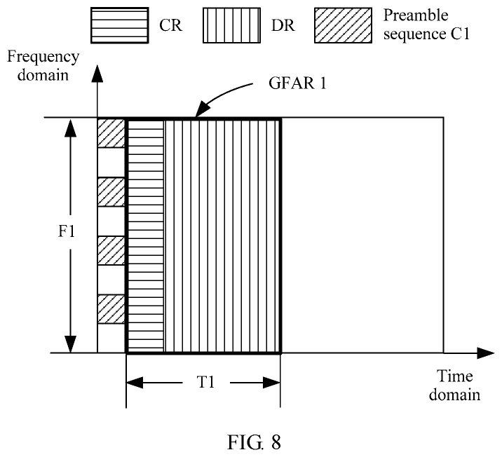

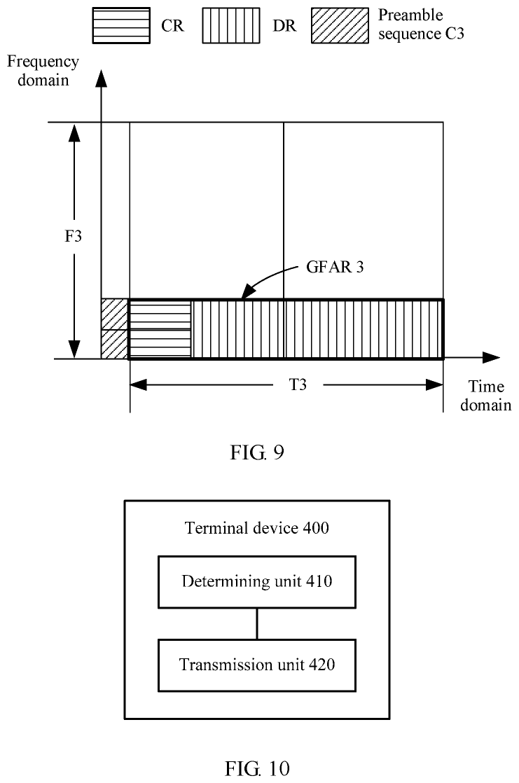

FIG. 8 and FIG. 9 are schematic diagrams of the time-frequency resource used for the grant-free transmission according to an embodiment of the present disclosure. The second location relationship is met between the time-frequency resource used to transmit the sequence and the time-frequency resource of the control signal, and the second location relationship is that: the time-frequency resource of the sequence is adjacent to the time-frequency resource of the control signal in time domain and is followed by the target time-frequency resource, and includes some frequency domain resources of the time-frequency resource of the control signal in frequency domain.

Referring to FIG. 8 and FIG. 9, after determining the target time-frequency resource GFAR, the terminal device determines a corresponding preamble sequence based on the GFAR, sends the preamble sequence to the network device at a location of a time-frequency resource of the preamble sequence, and sends the control signal and the uplink data to the network device on the GFAR, where the terminal device sends the control signal to the network device in the CR in the GFAR, and sends the uplink data in the DR in the GFAR, and further, adds, to the control signal, the information about the time-frequency resource of the uplink data, such as the bandwidth, the quantity of timeslots, and the start location. Then, the network device detects the preamble sequence on the time-frequency resource of the preamble sequence, the network device receives, on a CR corresponding to the preamble sequence based on the preamble sequence and the second location relationship between the preamble sequence and the CR, the control signal sent by the terminal device, and obtains, from the control signal, information about a DR used to receive the uplink data, so as to detect, on the DR, the uplink data sent by the terminal device.

It should be understood that determining the time-frequency resource of the control signal based on the time-frequency resource used by the terminal device to send the sequence is performed on a basis of the second location relationship that is met between the time-frequency resource of the sequence and the time-frequency resource of the control signal. However, to simplify the design during implementation, a part of the location information of the CR and the sequence may be agreed upon in advance. For example, it may be agreed that the time-frequency resource of the sequence is adjacent to the CR in time domain and is followed by the CR, the bandwidth of the time-frequency resources of the sequence is the same as the bandwidth of the CR, and the quantity of timeslots of the CR is related to the bandwidth of the CR, that is, may be determined by the bandwidth of the CR. Then, the network device may directly determine the start location and the bandwidth of the CR based on a time-frequency resource of the detected preamble sequence, and determine the quantity of timeslots of the CR based on the bandwidth of the CR, and may further determine the start location, the bandwidth, and the quantity of timeslots of the DR in the control signal in the CR. It may also be agreed that the CR is adjacent to the DR, the start location and the quantity of timeslots of the CR directly determine the start location of the DR, and the control signal may not include the start location of the DR. It may also be agreed that the bandwidth of the CR and DR is the same, the control message does not need to carry bandwidth information of the DR. When the transmission bandwidth of the DR includes only a possible quantity of timeslots of the DR, the control message does not need to indicate the quantity of timeslots of the DR. When data transmission supports the frequency hopping, the control message may also indicate the frequency hopping mode of the data transmission.

Because a specific location relationship is met between the time-frequency resource used to transmit the sequence and the time-frequency resource used to transmit the control signal, after receiving the sequence sent by the terminal device, the network device may directly determine, based on the time-frequency resource on which the sequence is received, the time-frequency resource used by the terminal device to transmit the control signal, and determine the resource used for the uplink grant-free transmission based on resource information carried in the control signal; that is, the sequence sent by the terminal device implicitly indicates the resource used for the uplink grant-free transmission, and no other signaling is required to indicate the resource, thereby reducing signaling overheads in the system.

In step 360, the network device detects uplink data sent by the terminal device on the target time-frequency resource.

In this embodiment of this disclosure, the terminal device indicates, by using the sequence sent to the network device, the time-frequency resource used for the grant-free transmission, so that the network device may effectively determine, by using information about the sequence sent by the terminal device, a time-frequency resource used by the terminal device for the grant-free access. Because reuse of a plurality of grant-free transmission resources is supported, effective utilization of radio transmission resources is implemented, transmission resources are saved, and utilization of the time-frequency resource is improved. Further, a transmission process may be simplified, and complexity of a receiver is reduced.

It should be understood that sequence numbers of the foregoing processes do not mean execution sequences in various embodiments of this disclosure. The execution sequences of the processes should be determined according to functions and internal logic of the processes, and should not be construed as any limitation on the implementation processes of the embodiments of this disclosure.

With reference to FIG. 10, the following describes a terminal device according to an embodiment of this disclosure. Technical features described in the method embodiment are applicable to the following apparatus embodiment.

FIG. 10 shows a terminal device 400 according to this embodiment of this disclosure. As shown in FIG. 10, the terminal device 400 includes a determining unit 410 and a transmission unit 420.

The determining unit 410 is configured to: determine a target time-frequency resource used for grant-free transmission from a plurality of time-frequency resources; and determine, based on information about the target time-frequency resource and a correspondence between a time-frequency resource and a sequence, a sequence corresponding to the target time-frequency resource.

The transmission unit 420 is configured to perform the grant-free transmission with a network device on the target time-frequency resource based on the sequence corresponding to the target time-frequency resource.

Therefore, the terminal device indicates, to the network device by using a preamble sequence, a time-frequency resource currently used for grant-free access, so that the network device can effectively determine the time-frequency resource selected by the terminal device to perform the grant-free access. Because the reuse of a plurality of grant-free transmission resources is supported, effective utilization of radio transmission resources is implemented, transmission resources are saved, and utilization of the time-frequency resource is improved. Further, a transmission process may be simplified, and complexity of a receiver is reduced.

In one embodiment, the determining unit 410 is specifically configured to determine, based on a size of to-be-sent uplink data or a loss status of a path between the terminal device and the network device, the target time-frequency resource used for the grant-free transmission from the plurality of time-frequency resources.

In one embodiment, the information about the target time-frequency resource includes at least one of the following information: a start location of the target time-frequency resource, a size of a frequency domain resource of the target time-frequency resource, a size of a time domain resource of the target time-frequency resource, or a frequency hopping mode of the terminal device.

In one embodiment, the transmission unit 420 is specifically configured to: send the sequence to the network device on a time-frequency resource used to send the sequence, and send uplink data to the network device on the target time-frequency resource.

In one embodiment, a first location relationship is met between the time-frequency resource of the sequence and the target time-frequency resource, and the first location relationship includes that: the time-frequency resource of the sequence is adjacent to the target time-frequency resource in time domain and is followed by the target time-frequency resource, and includes all or some frequency domain resources of the target time-frequency resource in frequency domain.

In one embodiment, the transmission unit 420 is specifically configured to: send the sequence to the network device on a time-frequency resource used to send the sequence, and send a control signal and uplink data to the network device on the target time-frequency resource, where the control signal includes information about a time-frequency resource used to transmit the uplink data.

In one embodiment, a second location relationship is met between the time-frequency resource of the sequence and a time-frequency resource used to transmit the control signal, and the second location relationship includes that: the time-frequency resource of the sequence is adjacent to the time-frequency resource of the control signal in time domain and is followed by the time-frequency resource of the control signal, and includes all or some frequency domain resources of the time-frequency resource of the control signal in frequency domain.

In one embodiment, the sequence includes a preamble sequence or a reference signal.

It should be understood that the terminal device 400 may correspond to the terminal device in the method embodiment, and may implement a corresponding function of the terminal device. For brevity, details are not described herein again.

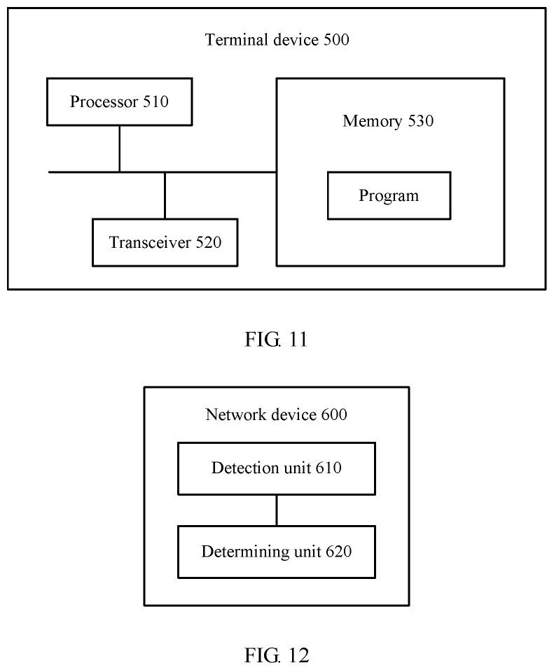

FIG. 11 is a schematic structural diagram of a terminal device 500 according to an embodiment of this disclosure. As shown in FIG. 11, the terminal device 500 includes a processor 510, a transceiver 520, and a memory 530. The processor 510, the transceiver 520, and the memory 530 communicate with each other using an internal connection path. The memory 530 is configured to store an instruction. The processor 510 is configured to execute the instruction stored in the memory 530 and to control the transceiver 520 to receive a signal or send a signal.

The processor 510 is configured to: determine a target time-frequency resource used for grant-free transmission from a plurality of time-frequency resources; and determine, based on information about the target time-frequency resource and a correspondence between a time-frequency resource and a sequence, a sequence corresponding to the target time-frequency resource.

The transceiver 520 is configured to perform the grant-free transmission with a network device on the target time-frequency resource based on the sequence that is determined by the processor 510 and that is corresponding to the target time-frequency resource.

Therefore, the terminal device indicates, to the network device by using a preamble sequence, a time-frequency resource currently used for grant-free access, so that the network device can effectively determine the time-frequency resource selected by the terminal device to perform the grant-free access. Because reuse of a plurality of grant-free transmission resources is supported, effective utilization of radio transmission resources is implemented, transmission resources are saved, and utilization of the time-frequency resource is improved. Further, a transmission process may be simplified, and complexity of a receiver is reduced.

In one embodiment, the processor 510 is specifically configured to determine, based on a size of to-be-sent uplink data or a loss status of a path between the terminal device and the network device, the target time-frequency resource used for the grant-free transmission from the plurality of time-frequency resources.

In one embodiment, the information about the target time-frequency resource includes at least one of the following information: a start location of the target time-frequency resource, a size of a frequency domain resource of the target time-frequency resource, a size of a time domain resource of the target time-frequency resource, or a frequency hopping mode of the terminal device.

In one embodiment, the transceiver 520 is specifically configured to: send the sequence to the network device on a time-frequency resource used to send the sequence, and send uplink data to the network device on the target time-frequency resource.

In one embodiment, a first location relationship is met between the time-frequency resource of the sequence and the target time-frequency resource, and the first location relationship includes that: the time-frequency resource of the sequence is adjacent to the target time-frequency resource in time domain and is followed by the target time-frequency resource, and includes all or some frequency domain resources of the target time-frequency resource in frequency domain.

In one embodiment, the transceiver 520 is specifically configured to: send the sequence to the network device on a time-frequency resource used to send the sequence, and send a control signal and uplink data to the network device on the target time-frequency resource, where the control signal includes information about a time-frequency resource used to transmit the uplink data.

In one embodiment, a second location relationship is met between the time-frequency resource of the sequence and a time-frequency resource used to transmit the control signal, and the second location relationship includes that: the time-frequency resource of the sequence is adjacent to the time-frequency resource of the control signal in time domain and is followed by the time-frequency resource of the control signal, and includes all or some frequency domain resources of the time-frequency resource of the control signal in frequency domain.

In one embodiment, the sequence includes a preamble sequence or a reference signal.

It should be understood that the processor 510 in this embodiment of this disclosure may be a central processing unit (Central Processing Unit, CPU), or the processor 510 may further be another general purpose processor, a digital signal processor (Digital Signal Processor, DSP), an application-specific integrated circuit (Application-Specific Integrated Circuit, ASIC), a field programmable gate array (Field Programmable Gate Array, FPGA), or another programmable logical device, discrete gate or transistor logical device, discrete hardware component, or the like. The general purpose processor may be a microprocessor, or the processor may be any conventional processor or the like.

The memory 530 may include a read-only memory and a random access memory, and provide the processor 510 with an instruction and data. A part of the memory 530 may further include a non-volatile random access memory. For example, the memory 530 may further store information of a device type.

In an implementation process, steps in the foregoing methods may be implemented by using a hardware integrated logical circuit in the processor 510, or by using an instruction in a form of software. The steps of the positioning method disclosed with reference to the embodiments of this disclosure may be directly performed by a hardware processor, or may be performed by using a combination of hardware in the processor 510 and a software module. The software module may be located in a mature storage medium in the art, such as a random access memory, a flash memory, a read-only memory, a programmable read-only memory, an electrically erasable programmable memory, a register, or the like. The storage medium is located in the memory 530, and the processor 510 reads information in the memory 530 and completes the steps in the foregoing methods in combination with hardware of the processor. To avoid repetition, details are not described herein again.

The terminal device 500 according to this embodiment of the present disclosure may be corresponding to the terminal device that is in the foregoing methods and that is configured to perform the methods shown in FIG. 3 to FIG. 8, and the terminal device 400 according to the embodiments of this disclosure. In addition, units or modules in the terminal device 500 are separately configured to perform actions or processing processes performed by the terminal device in the methods shown in FIG. 3 to FIG. 8. To avoid repetition, detailed descriptions are omitted herein.

FIG. 12 shows a network device 600 according to an embodiment of this disclosure. As shown in FIG. 12, the network device 600 includes a detection unit 610 and a determining unit 620.

The detection unit 610 is configured to detect a sequence sent by a terminal device.

The determining unit 620 is configured to determine, based on the sequence detected by the detection unit 610, information about a target time-frequency resource used for grant-free transmission.

The detection unit 610 is further configured to detect, on the target time-frequency resource determined by the determining unit 620, uplink data sent by the terminal device.

In this way, the network device can effectively determine a time-frequency resource used by the terminal device for grant-free access by using information about the sequence sent by the terminal device. Because reuse of a plurality of grant-free transmission resources is supported, effective utilization of radio transmission resources is implemented, transmission resources are saved, and utilization of the time-frequency resource is improved. Further, a transmission process may be simplified, and complexity of a receiver is reduced.

In one embodiment, the detection unit 610 is specifically configured to: before detecting the sequence sent by the terminal device, determine, based on signal power, whether the terminal device sends the sequence; and when determining that the terminal device sends the sequence, detect the sequence sent by the terminal device.

In one embodiment, the information about the target time-frequency resource includes at least one of the following information: a start location of the target time-frequency resource, a size of a frequency domain resource of the target time-frequency resource, a size of a time domain resource of the target time-frequency resource, or a frequency hopping mode of the terminal device.

In one embodiment, the determining unit 620 is specifically configured to determine the information about the target time-frequency resource based on the sequence and a correspondence between a sequence and a time-frequency resource.

In one embodiment, a first location relationship is met between a time-frequency resource used to transmit the sequence and the target time-frequency resource, and the first location relationship includes that: the time-frequency resource of the sequence is adjacent to the target time-frequency resource in time domain and is followed by the target time-frequency resource, and includes all or some frequency domain resources of the target time-frequency resource in frequency domain.

In one embodiment, the determining unit 620 is specifically configured to: determine, based on a time-frequency resource used to transmit the sequence, a time-frequency resource that is in the target time-frequency resource and that is used to transmit a control signal, and receive, on the time-frequency resource of the control signal, the control signal sent by the terminal device, where the control signal includes information about a time-frequency resource that is in the target time-frequency resource and that is used to transmit the uplink data; and determine, based on the control signal, the time-frequency resource that is in the target time-frequency resource and that is used to transmit the uplink data.

The detection unit 610 is specifically configured to detect, on the time-frequency resource that is in the target time-frequency resource and that is used to transmit the uplink data, the uplink data sent by the terminal device.

In one embodiment, a second location relationship is met between the time-frequency resource of the sequence and the time-frequency resource of the control signal, and the second location relationship includes that: the time-frequency resource of the sequence is adjacent to the time-frequency resource of the control signal in time domain and is followed by the time-frequency resource of the control signal, and includes all or some frequency domain resources of the time-frequency resource of the control signal in frequency domain.

In one embodiment, the sequence includes a preamble sequence or a reference signal.

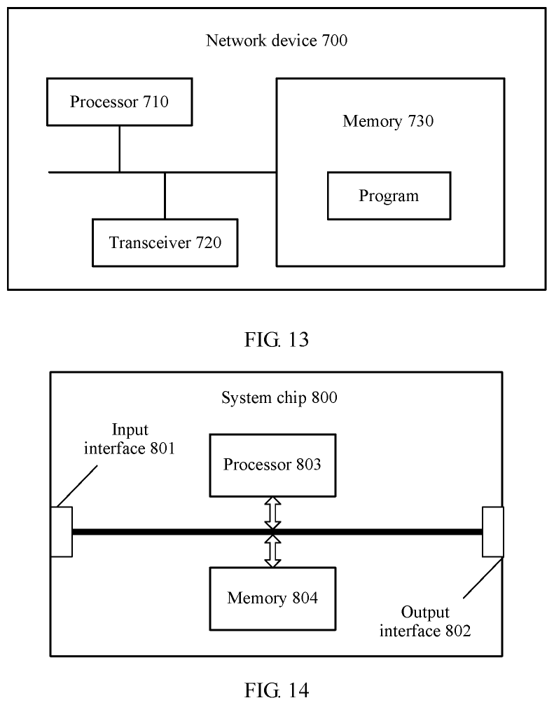

FIG. 13 is a schematic structural diagram of a network device 700 according to an embodiment of this disclosure. As shown in FIG. 13, the network device 700 includes a processor 710, a transceiver 720, and a memory 730, where the processor 710, the transceiver 720, and the memory 730 communicate with each other by using an internal connection path. The memory 730 is configured to store an instruction. The processor 710 is configured to execute the instruction stored in the memory 730, to control the transceiver 720 to receive a signal or send a signal.

The processor 710 is configured to: detect a sequence sent by a terminal device; determine, based on the detected sequence, information about a target time-frequency resource used for grant-free transmission; and detect, on the target time-frequency resource, uplink data sent by the terminal device.

In this way, the network device can effectively determine a time-frequency resource used by the terminal device for grant-free access by using information about the sequence sent by the terminal device. Because reuse of a plurality of grant-free transmission resources is supported, effective utilization of radio transmission resources is implemented, transmission resources are saved, and utilization of the time-frequency resource is improved. Further, a transmission process may be simplified, and complexity of a receiver is reduced.

In one embodiment, the processor 710 is specifically configured to: before detecting the sequence sent by the terminal device, determine, based on signal power, whether the terminal device sends the sequence; and when determining that the terminal device sends the sequence, detect the sequence sent by the terminal device.

In one embodiment, the information about the target time-frequency resource includes at least one of the following information: a start location of the target time-frequency resource, a size of a frequency domain resource of the target time-frequency resource, a size of a time domain resource of the target time-frequency resource, or a frequency hopping mode of the terminal device.

In one embodiment, the processor 710 is specifically configured to determine the information about the target time-frequency resource based on the sequence and a correspondence between a sequence and a time-frequency resource.

In one embodiment, a first location relationship is met between a time-frequency resource used to transmit the sequence and the target time-frequency resource, and the first location relationship includes that: the time-frequency resource of the sequence is adjacent to the target time-frequency resource in time domain and is followed by the target time-frequency resource, and includes all or some frequency domain resources of the target time-frequency resource in frequency domain.

In one embodiment, the processor 710 is specifically configured to: determine, based on a time-frequency resource used to transmit the sequence, a time-frequency resource that is in the target time-frequency resource and that is used to transmit a control signal, and receive, on the time-frequency resource of the control signal, the control signal sent by the terminal device, where the control signal includes information about a time-frequency resource that is in the target time-frequency resource and that is used to transmit the uplink data; and determine, based on the control signal, the time-frequency resource that is in the target time-frequency resource and that is used to transmit the uplink data.

The processor 710 is specifically configured to detect, on the time-frequency resource that is in the target time-frequency resource and that is used to transmit the uplink data, the uplink data sent by the terminal device.

In one embodiment, a second location relationship is met between the time-frequency resource of the sequence and the time-frequency resource of the control signal, and the second location relationship includes that: the time-frequency resource of the sequence is adjacent to the time-frequency resource of the control signal in time domain and is followed by the time-frequency resource of the control signal, and includes all or some frequency domain resources of the time-frequency resource of the control signal in frequency domain.

In one embodiment, the sequence includes a preamble sequence or a reference signal.

It should be understood that the processor 710 in this embodiment of this disclosure may be a central processing unit (Central Processing Unit, CPU), the processor 710 may further be another general purpose processor, a digital signal processor (Digital Signal Processor, DSP), an application-specific integrated circuit (Application-Specific Integrated Circuit, ASIC), a field programmable gate array (Field Programmable Gate Array, FPGA), or another programmable logical device, discrete gate or transistor logical device, discrete hardware component, or the like. The general purpose processor may be a microprocessor, or the processor may be any conventional processor or the like.

The memory 730 may include a read-only memory and a random access memory, and provide the processor 710 with an instruction and data. A part of the memory 730 may further include a non-volatile random access memory. For example, the memory 730 may further store information of a device type.

In an implementation process, steps in the foregoing methods may be implemented by using a hardware integrated logical circuit in the processor 710, or by using an instruction in a form of software. The steps of the positioning method disclosed with reference to the embodiments of this disclosure may be directly performed by a hardware processor, or may be performed by using a combination of hardware in the processor 710 and a software module. The software module may be located in a mature storage medium in the art, such as a random access memory, a flash memory, a read-only memory, a programmable read-only memory, an electrically erasable programmable memory, a register, or the like. The storage medium is located in the memory 730, and the processor 710 reads information in the memory 730 and completes the steps in the foregoing methods in combination with hardware of the processor. To avoid repetition, details are not described herein again.

The network device 700 according to this embodiment of the present disclosure may be corresponding to the network device that is in the foregoing methods and that is configured to perform the methods shown in FIG. 3 to FIG. 8, and the network device 600 according to the embodiments of this disclosure. In addition, units or modules in the network device 700 are separately configured to perform actions or processing processes performed by the network device in the methods shown in FIG. 3 to FIG. 8. To avoid repetition, detailed descriptions are omitted herein.

FIG. 14 is a schematic structural diagram of a system chip according to an embodiment of the present disclosure. A system chip 800 in FIG. 14 includes an input interface 801, an output interface 802, at least one processor 803, and a memory 804. The input interface 801, the output interface 802, the processor 803, and the memory 804 are connected to each other by using a bus 805. The processor 803 is configured to execute code in the memory 804.

In one embodiment, when the code is executed, the processor 803 may implement the method performed by the terminal device in the method embodiment. For brevity, details are not described herein again.

In one embodiment, when the code is executed, the processor 803 may implement the method performed by the network device in the method embodiment. For brevity, details are not described herein again.

It may be clearly understood by a person skilled in the art that, for the purpose of convenient and brief description, for detailed working processes of the foregoing system, apparatus, and unit, reference may be made to a corresponding process in the foregoing method embodiment, and details are not described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for detailed working processes of the foregoing system, apparatus, and unit, reference may be made to a corresponding process in the foregoing method embodiment, and details are not described herein again.

In the several embodiments provided in the present disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of the embodiments.

In addition, function units in the embodiments of the present disclosure may be integrated into one processing unit, or each of the units may exist alone physically, or two or more units may be integrated into one unit.

When the functions are implemented in the form of a software function unit and sold or used as an independent product, the functions may be stored in a computer readable storage medium. Based on such an understanding, the technical solutions of this disclosure essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this disclosure. The foregoing storage medium includes: any medium that can store program code, such as a USB flash drive, a removable hard disk, a read-only memory (Read-Only Memory, ROM), a random access memory (Random Access Memory, RAM), a magnetic disk, or a compact disc.

The foregoing descriptions are merely specific implementations of this application, but are not intended to limit the protection scope of the present disclosure. Any variation or replacement readily figured out by a person skilled in the art within the technical scope disclosed in this application shall fall within the protection scope of this application. Therefore, the protection scope of this disclosure shall be subject to the protection scope of the claims.

1. A grant-free transmission method comprising:
determining, by a terminal device, a target time-frequency resource used for a grant-free transmission from a plurality of time-frequency resources;
determining, by the terminal device, based on information about the target time-frequency resource and a correspondence between a time-frequency resource and a sequence, a sequence corresponding to the target time-frequency resource; and
performing, by the terminal device, the grant-free transmission with a network device on the target time-frequency resource based on the sequence corresponding to the target time-frequency resource.

2. The method according to claim 1, wherein determining, by the terminal device, the target time-frequency resource used for the grant-free transmission from a plurality of time-frequency resources comprises:
determining, by the terminal device, based on a size of to-be-sent uplink data or a loss status of a path between the terminal device and the network device, the target time-frequency resource used for the grant-free transmission from the plurality of time-frequency resources.

3. The method according to claim 1, wherein the information about the target time-frequency resource comprises at least one of:
a start location of the target time-frequency resource, a size of a frequency domain resource of the target time-frequency resource, a size of a time domain resource of the target time-frequency resource, or a frequency hopping mode of the terminal device.

4. The method according to claim 1, wherein performing, by the terminal device, the grant-free transmission with a network device on the target time-frequency resource based on the sequence corresponding to the target time-frequency resource comprises:
sending, by the terminal device, the sequence to the network device on a time-frequency resource used to send the sequence, and sending uplink data to the network device on the target time-frequency resource.

5. The method according to claim 4, wherein a first location relationship is met between the time-frequency resource of the sequence and the target time-frequency resource, and the first location relationship comprises:
the time-frequency resource of the sequence is adjacent to the target time-frequency resource in time domain and is followed by the target time-frequency resource and comprises all or some frequency domain resources of the target time-frequency resource in frequency domain.

6. The method according to claim 1, wherein performing, by the terminal device, the grant-free transmission with the network device on the target time-frequency resource based on the sequence corresponding to the target time-frequency resource comprises:
sending, by the terminal device, the sequence to the network device on a time-frequency resource used to send the sequence, and sending a control signal and uplink data to the network device on the target time-frequency resource, wherein the control signal comprises information about a time-frequency resource used to transmit the uplink data.

7. The method according to claim 6, wherein a second location relationship is met between the time-frequency resource of the sequence and a time-frequency resource used to transmit the control signal, and the second location relationship comprises:
the time-frequency resource of the sequence is adjacent to the time-frequency resource of the control signal in time domain and is followed by the time-frequency resource of the control signal, and comprises all or some frequency domain resources of the time-frequency resource of the control signal in frequency domain.

8. The method according to claim 1, wherein the sequence comprises a preamble sequence or a reference signal.

9. A grant-free transmission method comprising:
detecting, by a network device, a sequence sent by a terminal device;
determining, by the network device, based on the detected sequence, information about a target time-frequency resource used for a grant-free transmission; and
detecting, by the network device, on the target time-frequency resource, uplink data sent by the terminal device.

10. The method according to claim 9, further comprising, before detecting the sequence sent by the terminal device:
determining, by the network device based on a signal power, whether the terminal device sends the sequence; and when determining that the terminal device sends the sequence, detecting the sequence sent by the terminal device.

11. The method according to claim 9, wherein the information about the target time-frequency resource comprises at least one of:
a start location of the target time-frequency resource, a size of a frequency domain resource of the target time-frequency resource, a size of a time domain resource of the target time-frequency resource, and a frequency hopping mode of the terminal device.

12. The method according to claim 9, wherein the determining, by the network device based on the detected sequence, information about a target time-frequency resource used for grant-free transmission comprises:
determining, by the network device, the information about the target time-frequency resource based on the sequence and a correspondence between a sequence and a time-frequency resource.

13. The method according to claim 12, wherein a first location relationship is met between a time-frequency resource used to transmit the sequence and the target time-frequency resource, and the first location relationship comprises:
the time-frequency resource of the sequence is adjacent to the target time-frequency resource in time domain and is followed by the target time-frequency resource and comprises all or some frequency domain resources of the target time-frequency resource in frequency domain.

14. The method according to claim 9, wherein the determining, by the network device based on the detected sequence, information about a target time-frequency resource used for grant-free transmission comprises:
determining, by the network device based on a time-frequency resource used to transmit the sequence, a time-frequency resource in the target time-frequency resource, the time-frequency resource being used to transmit a control signal;
receiving, on the time-frequency resource of the control signal, the control signal sent by the terminal device, wherein the control signal comprises information about a time-frequency resource in the target time-frequency resource, the time-frequency resource being used to transmit the uplink data; and
determining, by the network device based on the control signal, the time-frequency resource that is in the target time-frequency resource and that is used to transmit the uplink data; and, wherein
detecting, by the network device on the target time-frequency resource, uplink data sent by the terminal device comprises:
detecting, by the network device on the time-frequency resource that is in the target time-frequency resource and that is used to transmit the uplink data, the uplink data sent by the terminal device.

15. The method according to claim 14, wherein a second location relationship is met between the time-frequency resource of the sequence and the time-frequency resource of the control signal, and the second location relationship comprises:
the time-frequency resource of the sequence is adjacent to the time-frequency resource of the control signal in time domain and is followed by the time-frequency resource of the control signal and comprises all or some frequency domain resources of the time-frequency resource of the control signal in frequency domain.

16. The method according to claim 9, wherein the sequence comprises a preamble sequence or a reference signal.

17. A terminal device comprising:
a determining unit configured to:
determine a target time-frequency resource used for a grant-free transmission from a plurality of time-frequency resources; and
determine, based on information about the target time-frequency resource and a correspondence between a time-frequency resource and a sequence, a sequence corresponding to the target time-frequency resource; and
a transmission unit configured to perform the grant-free transmission with a network device on the target time-frequency resource based on the sequence that is determined by the determining unit and that is corresponding to the target time-frequency resource.

18. The terminal device according to claim 17, wherein the determining unit is further configured to:
determine, based on a size of to-be-sent uplink data or a loss status of a path between the terminal device and the network device, the target time-frequency resource used for the grant-free transmission from the plurality of time-frequency resources.

19. The terminal device according to claim 17, wherein the information about the target time-frequency resource comprises at least one of:
a start location of the target time-frequency resource, a size of a frequency domain resource of the target time-frequency resource, a size of a time domain resource of the target time-frequency resource, and a frequency hopping mode of the terminal device.

20. The terminal device according to claim 17, wherein the transmission unit is further configured to:
send the sequence to the network device on a time-frequency resource used to send the sequence, and send uplink data to the network device on the target time-frequency resource.
